(19) United States
(12) Patent Application Publication
(10) Pub. No.: US 2011/0003273 A1
(43) Pub. Date: Jan. 6, 2011

(54) TEACHING AID FOR CORRECT USE OF CUTLERY BY CHILDREN

(75) Inventor: Graeme Siegmund Roggensack, Queensland (AU)

Correspondence Address: Joseph R. Baker, APC;Gavrilovich, Dodd & Lindsey LLP, 4660 La Jolla Village Drive, Suite 750, San Diego, CA, 92122, US

(73) Assignee: Graeme Siegmund Roggensack, Cairns, Queensland (AU)

(21) Appl. No.: 12/161,340

(22) PCT Filed: Dec. 18, 2006
(86) PCT No.: PCT/AU2006/001924

§ 371 Date: Jul. 18, 2008

(30) Foreign Application Priority Data
Jan. 19, 2006 (AU) 2006200217

(51) Int. Cl. G09B 19/00; A47J 43/28

(52) U.S. Cl. 434/127; 30/123

(57) ABSTRACT

Cutlery for use by children to assist in correct holding of the cutlery, the cutlery comprising a handle portion and a head portion (the head portion typically including a knife blade, the fork prongs, or a dished portion), and a means to enable a finger of a person's hand to be positioned on the handle and/or the head portion.

### FIELD OF THE INVENTION

This invention is directed to cutlery (knife, fork, spoon etc) which has a special design such that the cutlery can be held in the proper manner by children and therefore can be used as a teaching aid for the correct use of a knife, fork or spoon.

### BACKGROUND ART

Teaching children to use tableware such as a knife, fork or spoon can be quite difficult and frustrating. Children have a natural tendency to clench their fists around the cutlery handles which makes eating difficult and messy. Correct use of spoons is a particular challenge.

Many attempts have been made to try to design cutlery or to provide attachments to cutlery to make it easier for children to eat properly. Thus, it is known to provide attachments to a knife, fork or spoon which can be attached and removed. These attachments can comprise some form of “blocking member” on the handle that prevents the handle from being grasped by the child in the wrong place. WO 961-0939 describes such a device, as does Japanese patent application 2004057788. It is also known to provide a special handle shape or handle moulding to force the handle to be gripped in the right manner. An example of this is described in Japanese patent application 2004249042. A disadvantage with this arrangement is that it is quite expensive to make specially designed handles, and the handle is usually only suitable for a certain hand size which means that these handles are quite limited in use.

Existing attempts seem to either rely upon a complicated contour on the handle which has the disadvantage of being expensive, and not comfortable to be used by other people (e.g. adults), or attachments that need to be attached to otherwise conventional cutlery.

The present invention is directed to a modification to a table knife and fork which can be otherwise quite conventional, and where the modification is such that the knife and fork can still be used by adults quite comfortably, does not necessarily require a portion that has to be attached and removed every time, and where the modification is such that the cutlery can be used as a teaching aid for children of different ages and therefore with different hand sizes. The present invention can also extend to a tablespoon similar to that described above, although the present invention also envisages a tablespoon of slightly different design (and therefore not entirely conventional), but which still incorporates the modification.

The present invention has also been devised with the realisation that training in correct use of cutlery does not necessarily require the entire hand to be forced into a particular position. Instead, it has been found that if the index finger can be placed in a particular position, the remainder of the hand is likely to adopt the “correct” position for use with a knife and fork. With a spoon, it is found that if the person's thumb can be placed in the correct position, it is much easier to hold spoon correctly.

It will be clearly understood that, if a prior art publication is referred to herein, this reference does not constitute an admission that the publication forms part of the common general knowledge in the art in Australia or in any other country.

### OBJECT OF THE INVENTION

It is an object of the invention to provide cutlery which may overcome at least some of the above-mentioned disadvantages or provide a useful or commercial choice.

In one form, the invention resides in cutlery for use by children to assist in correct holding of the cutlery, the cutlery comprising a handle portion and a head portion (the head portion typically including a knife blade, the fork prongs, or a dished portion), and a means to enable the index finger, or a thumb of a person's hand to be positioned on the handle and/or the head portion.

In this form of the invention, it is found that if the index finger can be positioned in the correct place, it is quite easy to teach a child to hold a knife and fork correctly. Thus, complicated handle designs are not required. Also, the knife and fork can otherwise be quite conventional, and can be used by adults as well. In this form of the invention, it is found that, in respect of spoons, the means is such to enable the child's thumb to be positioned in a particular manner which makes it easier to hold a spoon correctly.

The means will typically comprise some form of location means. The location means will typically comprise at least one depression, recess, divot, opening and the like which can be “felt” by the index finger (or thumb, particularly in respect of spoons) to allow the index finger to be located without needing to constantly look at where the finger is. An advantage of having a “depression” is that it is found that children naturally like to place their fingers over openings and depressions and it is quite easy for the child to keep their finger in position. It is particularly found that if an opening is formed (e.g. drilled) through, or at least partially through the cutlery, a child will typically be quite keen to close the opening with their index finger which will also place the index finger in the right position. The opening may have a diameter of between 1-10 mm, and may be associated with a larger depression.

If necessary, a plurality of location means may be provided on the cutlery, and there may be an advantage in doing this to enable the cutlery to be used as a training aid for children of different ages, hand sizes and the like.

The cutlery may comprise a knife, a fork, a spoon, and the like. The cutlery may be specially designed, although one non-limiting advantage of the present invention is that “ordinary” cutlery can be modified (for instance drilled with an opening), to provide the teaching aid for children. Another non-limiting advantage is that if the location means comprises a depression/opening etc, this will not unduly interfere with the use of the cutlery by adults, which makes the cutlery more versatile.

The cutlery may be made from any suitable material and cutlery is typically made of metal, plastic and the like. The cutlery may also comprise any suitable shape or size.

The cutlery will typically contain a handle portion (which is quite conventional), and a head portion. The head portion will typically either comprise a knife blade (for a knife), a plurality of prongs (for a fork) or a dished portion (for a spoon). Depending on the particular design of the cutlery, the exact junction between the handle and the head portion is sometimes difficult to determine.

The means to enable the index finger of a person's hand to be positioned on the handle and/or head portion will typically be at, or adjacent, the junction between the handle and the head portion of the knife of fork. Sometimes, the means will be more on the head portion, and sometimes the means will be more on the handle portion, at the means will preferably be in this general area to enable the cutlery to be properly held.

In another form, the invention resides in cutlery for use by children to assist in correct holding of the cutlery, the cutlery comprising a handle portion and a head portion (the head portion typically including a knife blade, the fork prongs, or a dished portion), and a divot such as a depression and/or opening in the handle portion and/or the head portion but generally in the area where the handle portion and the head portion meet each other, the depression and/or opening functioning to assist children in correct holding of the cutlery.

The depression may comprise a divot, recess, groove, and the like. The opening may extend entirely through or partially through the cutlery. The shape and size of the depression or opening can vary to suit providing that it can be “felt” by a child, and particularly by a child's finger in respect of a knife or fork or the child's thumb in respect of a spoon. A plurality of depressions and/or openings may be provided.

Preferably there is provided cutlery consisting of a knife or a fork and for use by a person to assist in correct holding of the cutlery, the cutlery comprising a handle portion and a head portion which comprises a knife blade or fork prongs and a small hole which is in the cutlery and adapted to locate a finger tip of the person to enable the cutlery to be held in the proper manner, the hole, for the fork being on the back of the fork and behind the fork prongs, and for the knife, being behind the knife blade.

Preferably, the cutlery comprises a spoon which has a handle portion and a dish portion and a small hole which is in the handle portion and adapted to locate a thumb of the spoon user to enable the spoon to be held in the proper manner and wherein the hole passes through the cutlery.

Preferably, the hole is in a divot formed in one side only of the cutlery.

Preferably, the cutlery comprises a table knife.

Preferably, the cutlery comprises a table fork.

Preferably, the finger tip is an index finger tip.

Preferably, the cutlery comprises a spoon wherein the hole is in a divot formed in one side only of the handle of the spoon. Preferably, the hole extends through the cutlery.

Preferably, the cutlery comprises a knife, the knife handle portion being flattened and being substantially at right angles to the plane of the knife blade. Preferably, the hole is in a divot which extends in a flattened portion between the handle portion and the knife blade.

Preferably, the cutlery comprises a fork, wherein the hole is in a divot which is in the head portion of the fork.

Preferably, the cutlery comprises a spoon and for use by a person to assist in correct holding of the spoon, the spoon comprising a handle portion and a head portion and a small hole which is in the handle portion and adapted to locate a thumb of the person to enable the cutlery to be hold in the proper manner.

Preferably, the handle portion has an upper face and a lower face, the hole being in a divot which is in the upper face, the divot being positioned in a rear portion of the handle portion.

### BRIEF DESCRIPTION OF THE DRAWINGS

An embodiment of the invention will be described with reference to the following drawings in which:

FIGS. 1-2. Illustrate a fork.

FIGS. 3-4. Illustrate a knife.

FIGS. 5-6. Illustrate a spoon.

FIGS. 7-11. Illustrate use of the cutlery

FIG. 12. Illustrates the knife, fork and spoon combination together.

### BEST MODE

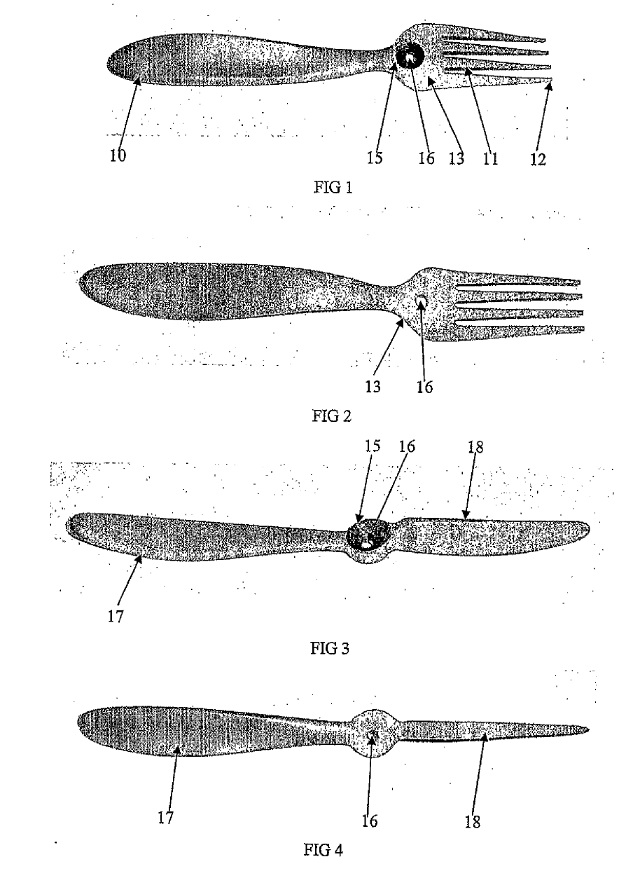

Referring to the drawings and initially to FIGS. 1-2, there is illustrated a modified table fork. The table fork contains a handle portion 10 and a head portion 11 with the head portion containing the fork prongs 12. The head portion contains the prongs 12 at one end, and a base portion 13 at the other end, with the handle portion 10 merging with the base portion 13. Positioned on base portion 13 is a location means 14. In the particular embodiment, the location means 14 comprises a larger recess (this can also be called a divot) portion 15 (see particularly FIG. 2). At the bottom of larger portion 15 is an opening/hole 16 that extends through the fork.

It is found that children have a natural tendency to place their fingers in or over depression or holes, and therefore the arrangement of portion 15 and opening 16 seems to be quite satisfactory for this purpose. A child places their index finger over portion 15, and this results in the fork being held correctly, or enables the child to quickly learn how to hold the fork correctly and in a comfortable manner.

The fork can be otherwise quite conventional in design.

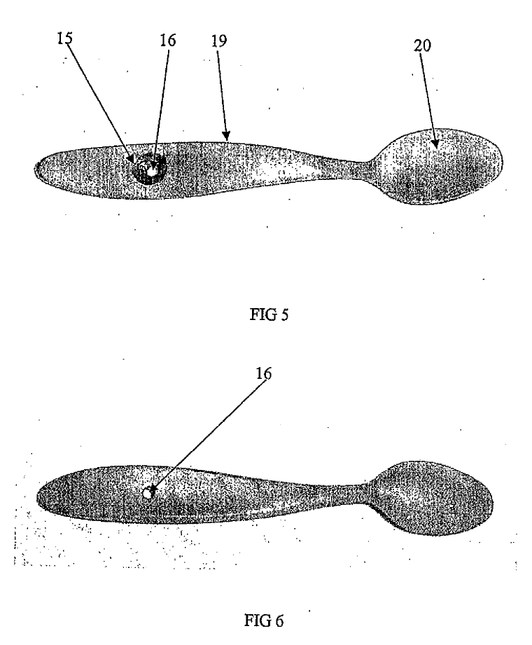

FIGS. 3-4 illustrates a knife which comprises a handle portion 17 and a blade 18 and a location means which is similar to that described with reference to the fork and therefore comprises divot portion 15 and opening 16. Again, a child can locate their index finger over portion 15 to enable the knife to be held correctly.

In the particular embodiment, the handle 17 of the knife is broader (wider) across the top then would otherwise be the case, to provide sufficient room for portion 15 to be formed (typically by drilling) into the handle. Of course, the handle could also be of conventional design and a broader part could be attached where the handle meets the blade 18 and the broader part can then be drilled or otherwise formed with portion 15 and opening 16.

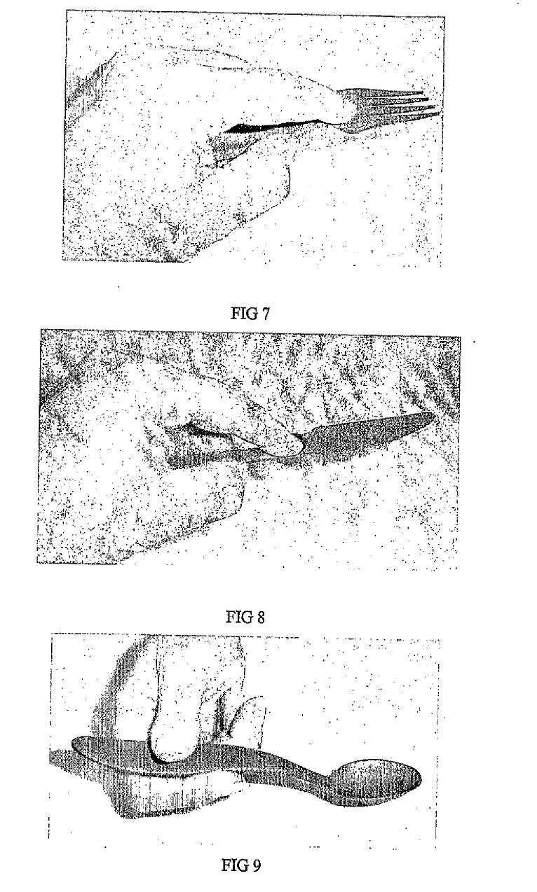

FIGS. 5-6 illustrates a spoon. The spoon again has a handle 19, and a dished “spoon” portion 20. Handle 19 in the particular embodiment is quite broad across the top. The location means is provided and again comprises divot portion 15 and opening 16. A spoon is, of course, held differently to a knife and fork, and the arrangement here is that portion 15 is covered by the child's thumb. The broad curved handle allows the fingers on the other side of the handle to automatically find a practical and comfortable location. The downwardly curved edges maintain a level spoon head. This is achieved when the thumb is on the location means (e.g. portion 15) as the spoon handle edge then rests between the thumb and the knuckle of the index finger.

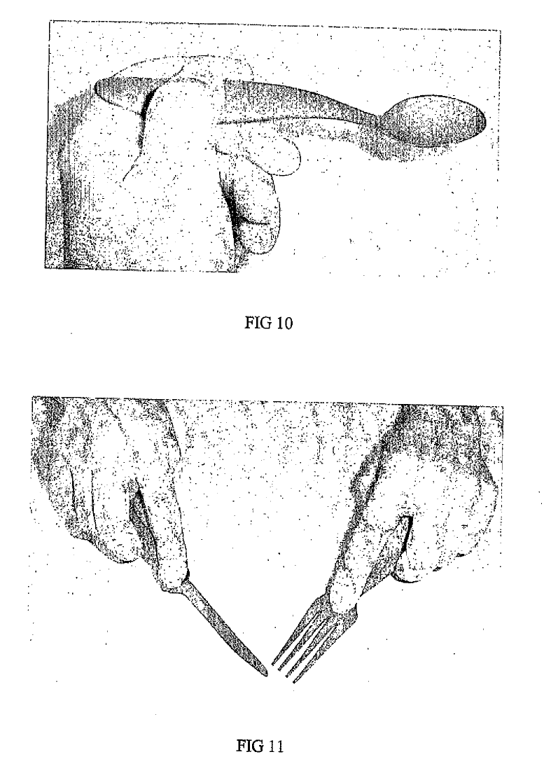

FIGS. 7-11 Illustrate use of the cutlery

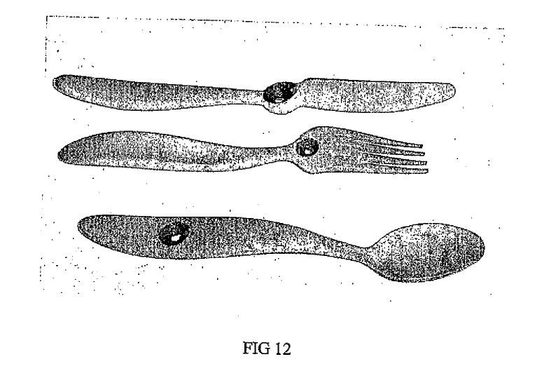

FIG. 12 Illustrates the knife, fork and spoon combination together. Throughout the specification and the claims (if present), unless the context requires otherwise, the term “comprise”, or variations such as “comprises” or “comprising”, will be understood to apply the inclusion of the stated integer or group of integers but not the exclusion of any other integer or group of integers.

Throughout the specification and claims (if present), unless the context requires otherwise, the term “substantially” or “about” will be understood to not be limited to the value for the range qualified by the terms.

It should be appreciated that various other changes and modifications can be made to any embodiment described without departing from the spirit and scope of the invention.

1. Cutlery consisting of a knife or a fork and for use by a person to assist in correct holding of the cutlery, the cutlery comprising a handle portion and a head portion which comprises a knife blade or fork prongs and a small hole which is in the cutlery and adapted to locate a finger tip of the person to enable the cutlery to be held in the proper manner, the hole, for the fork being on the back of the fork and behind the fork prongs, and for the knife, being behind the knife blade.

2. Cutlery of claim 1, further comprising a spoon which has a handle portion and a dish portion and a small hole which is in the handle portion and adapted to locate a thumb of the spoon user to enable the spoon to be held in the proper manner and wherein the hold passes through the cutlery.

3. Cutlery of claim 1, wherein the hole is in a divot formed in one side only of the cutlery.

4. Cutlery as claimed in any one of claims 1-3 comprising a table knife.

5. Cutlery as clamed in any one of claims 1-3 comprising a table fork.

6. Cutlery of any one of claims 1-3, wherein the finger tip is an index finger tip.

7. Cutlery of claim 1, comprising a spoon wherein the hole is in a divot formed in one side only of the handle of the spoon.

8. Cutlery of claim 1, wherein the hole extends through the cutlery.

9. Cutlery of claim 1, comprising a knife, the knife handle portion being flattened and being substantially at right angles to the plane of the knife blade.

10. Cutlery of claim 9, wherein the hole is in a divot which extends in a flattened portion between the handle portion and the knife blade.

11. Cutlery of claim 1 comprising a fork, wherein the hole is in a divot which is in the head portion of the fork.

12. Cutlery comprising a spoon and for use by a person to assist in correct holding of the spoon, the spoon comprising a handle portion and a head portion and a small hole which is in the handle portion and adapted to locate a thumb of the person to enable the cutlery to be held in the proper manner.

13. Cutlery of claim 12, wherein the handle portion has an upper face and a lower face, the hole being in a divot which is in the upper face, the divot being positioned in a rear portion of the handle portion.
